(19) United States
(12) Patent Application Publication
(10) Pub. No.: US 2018/0308374 A1
(43) Pub. Date: Oct. 25, 2018

(54) On-Demand Tutoring Service

(71) Applicant: Jes Tougaard GRAM, Scottsdale, AZ (US)

(72) Inventor: Jes Tougaard GRAM, Scottsdale, AZ (US)

(21) Appl. No.: 15/864,567

(22) Filed: Jan. 8, 2018

Related U.S. Application Data
(60) Provisional application No. 62/443,322, filed on Jan. 6, 2017.

(51) Int. Cl. G09B 5/06

(52) U.S. Cl. CPC G09B 5/065

(57) ABSTRACT

A method for providing on-demand service information is provided. One or more processors determine, for a given topic and or category, illustrating in writing, by voice, video, picture, scan or other form of communication the requested information for each of a plurality of requesters for an on-demand service and assignment information for each of a plurality of service providers that can provide the on-demand service. A plurality of sub-topics is identified for the given assignment. Based, at least in part, on the topic information of the requesters and the service providers, one or more sub-topics are determined as being under-supplied by the plurality of service providers as compared to one or more other sub-topics. Information identifying the under-supplied sub-topics is provided to one or more service provider devices.

### BACKGROUND

There are many students that across the world that are faced with educational challenges in an assignment/homework or studies where a little help would ease the work and learning process. The challenge for many students are where to get such help when needed, since access to teachers or people with the relevant knowledge outside school can be difficult to find at the time when a question or the need for explanation arises unless planed for using e.g. a tutor at a prearranged time.

The invention concerns a method to solve the above-mentioned need by offering an on-demand tutoring service preferably capable of servicing across the world and 24/7.

There are many real-world services that a user can access through a mobile and/or stationary computing device. An example could be a service like Uber® where a user can request transportation services or delivery services by operating a mobile computing device.

Such services are often limited by geographical or availability restrictions for such services due to insufficient number of suppliers at a given time or location and the time the user must wait to be serviced can therefore depend on many factors.

### DETAILED DESCRIPTION

Examples described herein provide for a system to provide real-time on-demand tutoring service that identifies topics that are under-served or over-served by service providers. Using this information, service providers can shift to different topics/level of educational challenge if qualified in order to provide a broader service and increase business by e.g. expand the grade level serviced in math to include both middle school and high school. The service of this app includes a certain level of screening of the service providers and their credentials and potentially also criminal records.

It can also offer a feature that enables the customers to give customer satisfaction reviews and scores.

According to some examples, topic and assignment information for each of a plurality of requesters and for each of a plurality of service providers are determined for a given education level. The requesters and services providers can be parties for an on-demand service, such as a 5^{th} grader in need of math tutoring provided by a high school student in need of a part time job outside school hours. A plurality of sub-topics is identified for the given educational level/type of class. Based, at least in part, on the topic information of the requesters and the service providers, one or more sub-topics can be determined to be under-supplied by the service providers as compared to one or more other sub-topics. Information identifying the under-supplied sub-topic(s) can be provided to one or more computing devices associated with the requesters and/or the service providers.

In one example, one or more sub-topics can be determined to be under-supplied by determining, for each of the plurality of sub-topics, an amount of requesters and an amount of service providers in that educational field. A sub-topic can be under-supplied if the ratio of the amount of requesters to the amount of service providers in that region is greater than a threshold ratio.

The information that identifies under-supplied sub-topics and/or over-supplied sub-topics can be used to nudge inactive or active suppliers to a certain time-slots and also to change cost structure or service offerings provided by the service/app.

This can e.g. be done as visualizations that are to be displayed on one or more computing devices of the requesters and/or service providers. In some examples, the visualizations can be provided in conjunction with a topic group e.g. math of the given educationally level that identifies the sub-topics. The visualizations can distinguish sub-topics that are under-supplied from other sub-regions in the given educationally level or topic using different language, text and/or other visual graphics.

In some examples, one or more sub-topics can be determined to be under-supplied by the service providers as compared to one or more other sub-topics by forecasting or making a prediction for a future instance in time (e.g., a time ahead of the current time) that a sub-topic will be under-supplied at the future instance in time. Forecasting that a sub-topic will be under-supplied can be based, at least in part, on historical data that is comparable to the future instance in time. In this manner, a service provider can, for example, recognize which sub-topics will be under-supplied in the future instance in time (e.g., an hour from the current time), and move to a particular educational class level to increase business (e.g. based on average bedtime schedule for a certain age group).

As described herein, a “user,” a “requester,” or a “customer” are invariably used to refer to individuals that are requesting or ordering a service. Also as described herein, a “provider,” a “service provider,” a “supplier,” or a “vendor” are invariably used to refer to individuals or entities that can provide the service. As an example, a user can request a service, such as a help with a Spanish assignment or an explanation to a math equation using the app/service, and a service provider/tutor, such as a teacher, a student or a person/“tutor” with the right credentials, can communicate with the system and/or the user to arrange for the service. In addition, as described herein, “requesting devices” and “provider devices” refer to computing devices that can correspond to desktop computers, cellular or smartphones, laptop computers, tablet devices, television (IP Television), etc., that can provide network connectivity and processing resources for enabling a user to communicate with a system over a network.

A preferred method for the requester to submit a tutor request from the suppliers is to choose a category/topic and potentially also a grade level and submit a picture or a scan of the assignment or topic in question in order for the tutor to preform a real time online explanation/tutoring of the exact problem facing the student/customer e.g. using a tablet or other device capable of interacting directly with the assigned picture or scan writing/drawing an explanation of how best to resolve and understand the problem at hand.

The app/service could also be capable of keeping different levels of anonymity for both requester and supplier e.g. having/controlling one-way video communication through WebEx, Facetime® or a similar service insuring the requesters' privacy while maybe allowing voice enabled from the requester with an voice change feature.

Having the anonymity feature might overcome a customer fear of asking a “dumb” question and thereby better enable the understanding of a certain topic.

The app/service could also offer a surveillance of the tutoring service insuring that nothing inappropriate or topics outside the tutoring is taking place when minors use the service. This could either be by human supervision and/or a word recognition activated system making an alert when preset/inappropriate language is used.

The app/service could also have a predetermined grace period for customers to complain against services rendered before funds where transferred to the supplier.

The app/service could also have a block feature enabling blocking of the access to the app/service e.g. for misuse or unwanted behavior of use.

The app/service could have the option to record all tutor sessions to enable verify level of supplied services and potential disagreements.

The app/service could have the option to rate the different tutor sessions to enable other customers to review the level of supplied services from individual tutors.

The app/service could have a training service and/or requirement for the suppliers that could enhance the service level and ensure a more uniform service level for the customers using the app/service.

The app/service could have simulation module ensuring the training of the suppliers and their level of service on a regular basis.

The app/service could also be enabled to interact with own and/or third party digital educational material through a screen-sharing feature.

The app/service could have the option to offer translation services of documents/texts from one or more languages to one or more other languages and also potentially having a certifications service like a notary. Becoming a digital notary service and/or other certification service of translated documents.

The app/service could have the option to offer quote and/or auction services of the different assignments with a potential time factor option for completion of the assignment.

The app/service could also have a screen-sharing feature that ensured that no access granted to the customers device from the suppliers device and/or from the suppliers device to the customers device. This could e.g. be achieved by common/mutual access point enabling this service provided by the app/service and/or a separate contractor.

The app/service could also have group sessions where multiple customers could sign up and/or sign in to a live tutoring on specific topics at a special rate.

The app/service could also have a shared monitoring feature. This could e.g. include a monitoring feature that informed a parent, teacher or other adult about participation and/or interaction level/time under and/or after a tutoring session.

A provider device could also correspond to predetermined time cost (e.g. cost per hour, per minute or per session/sessions). A quote system enabling negotiation between a customer and a supplier can also be incorporated in the app/service.

The app/service could also include a payment service that enables both a direct payment service, but also a prepaid service enabling use without the help of an adult or the need for a credit card to use the service.

The app/service could also include a charity feature that aloud people and/or organizations to donate funds for education based on certain requirements giving specific users aces on discounted or on a free basis.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions.

As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, tablets, laptop computers, printers, scanners, digital picture frames, projectors, network equipment and wearable devices.

Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium.

### System Description

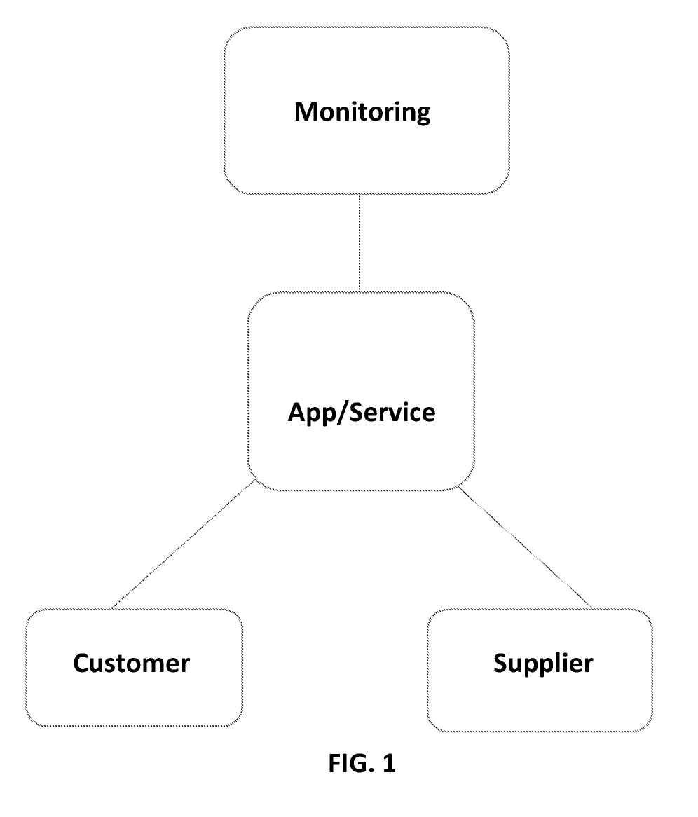

FIG. 1 illustrates an example system for providing on-demand service information to one or more computing devices. In some examples, the on-demand service information can identify under-supplied (or under-served) areas to assist service providers in real-time on where and/or what category to offer their services. Under-supplied topics (or sub-topics) of a given topics can be determined based, at least in part, on the request information received from requesters and service providers. The system also offers a monitoring service with the possibility to have different restriction levels.

What is claimed is:

1. A method for providing information for an on-demand tutoring and/or translation service, the method being performed by a computing system and comprising:
receiving assignment from a requester, by the computing system, provider data from mobile and/or stationary computing devices that are operated by a group of service providers, the provider data being generated by a service application on a respective mobile and/or stationary computing device of each service provider in the group, wherein receiving provider data includes receiving topic information from the respective mobile and/or stationary computing device of each service provider;
determining, based, at least in part, on the user data, (i) a user state of the mobile computing device of each individual, the user state indicating whether each individual is currently receiving the on-demand service, and (ii) a set of individuals who launched the service application within a designated duration of time that is deemed to be indicative of interest for requesting service within a given topic and timeframe;
determining, based, at least in part on the provider data, a provider state of each service provider in the group that is within the given topic and timeframe; and
determining a supply level of the given topic and timeframe based at least in part on (i) individuals other than those having the user state that indicates that the on-demand service is being received, (ii) the set of individuals, and (iii) the provider state of each service provider within the given topic and timeframe.

2. The method of claim 1, further comprising:
providing, from the computing system to a set of mobile and/or stationary computing devices operated by a respective set of service providers in the group, information about the supply level of the given topic and timeframe.

3. The method of claim 2, wherein the information about the supply level of the given topic and timeframe can be used by the service application of each mobile and/or stationary computing device of the respective set of mobile and/or stationary computing devices to display content about the supply level of the given topic and timeframe to the respective set of service providers.

4. The method of claim 2, wherein the provider state indicates whether each service provider is available to provide the on-demand service, and wherein determining the supply level of the given topic and timeframe includes (i) determining a ratio of (a) a number of individuals in the set of individuals that do not have the user state that indicates that the on-demand service is being received, to (b) a number of service providers having the provider state that indicates availability to provide the on-demand service, and (ii) comparing the ratio to a threshold ratio.

5. The method of claim 2, wherein the information about the supply level of the given topic and timeframe can be used by the service application of each mobile and/or stationary computing device of the respective set of mobile and/or stationary computing devices to display a visualization of the topic and/or an explanation on how to solve or go about solving the task at hand or as part of a user interface that includes the given topic.
